(19) United States
(12) Patent Application Publication
(10) Pub. No.: US 2022/0263156 A1
(43) Pub. Date: Aug. 18, 2022

(54) Methods and Apparatus for a Sealed Battery System

(71) Applicant: Atlis Motor Vehicles, Inc., Mesa, AZ (US)

(72) Inventors: Mark Hanchett, Mesa, AZ (US); Archit Deshpande, Mesa, AZ (US)

(73) Assignee: Atlis Motor Vehicles, Inc., Mesa, AZ (US)

(21) Appl. No.: 17/588,500

(22) Filed: Jan. 31, 2022

Related U.S. Application Data
(60) Provisional application No. 63/144,589, filed on Feb. 2, 2021.

(51) Int. Cl. H01M 10/6556; H01M 10/613; H01M 10/63; H01M 10/6568; F28D 7/16

(52) U.S. Cl. CPC H01M 10/6556; H01M 10/613; F28D 7/16; H01M 10/6568; H01M 10/63

(57) ABSTRACT

In an example embodiment, sill battery system uses heat exchangers, a liquid coolant, and/or circulators to manage the temperature of the battery system. Sensors capture data from different areas of the battery system. A circulation controller receives the data from the sensors and controls the circulators in accordance with the data to increase heat transfer in some portions of the battery system while decreasing or maintaining heat transfer in other portions of the battery system. Circulators may include a motor and a thruster. The motor may drive the thruster to circulate the liquid coolant using a rotating magnetic field.

### BACKGROUND

Embodiments of the present invention relate to batteries and battery systems.

Charging and discharging a battery may result in the production of heat. Battery performance in cold weather may improve by heating the battery. In many circumstances, a battery may need to either expel heat or receive heat. A sealed battery may benefit from heat exchangers (e.g., heatsinks), a liquid coolant and/or circulators. A sealed battery may benefit from a liquid coolant sealed in the container of the battery system, circulators to circulate the liquid coolant, sensors to detect the physical properties of the battery blocks of the battery system, and a circulation controller that controls the circulation of the liquid coolant inside the sealed battery in accordance with data from the sensors.

### SUMMARY

Some of the various embodiments of the present disclosure relate to a battery system. Various embodiments include a container that encloses the battery blocks and a liquid coolant. Example embodiments of the battery system further include heat exchangers. The heat exchangers may be thermally coupled to the battery blocks, an inside surface of the container of the battery system, and an outside surface of the container. The container is sealed to retain a liquid coolant inside a cavity of the container. The liquid coolant is circulated in the container to transfer heat between the battery blocks and the exterior of the container via the heat exchangers, the liquid coolant, the wall of the container, and a fluid medium that surrounds the exterior of the container.

Various embodiments include circulators that circulate the liquid coolant inside the cavity of the container. A circulator includes a motor and a thruster. The motor drives the thruster. The thruster circulates the liquid coolant. In one embodiment, a shaft of the motor pierces the container to drive the thruster to circulate the liquid coolant. In other embodiments, the motor induces a rotating magnetic field that penetrates (e.g., passes through) the wall of the container to drives the thruster to circulate the liquid coolant. The rotating magnetic field passes through the wall of the container without piercing the container, so the container can retain the liquid coolant.

Other various embodiments of the present disclosure include sensors and a circulation controller. The sensors and the battery blocks are distributed throughout the cavity of the container. The sensors capture and report data regarding physical characteristics in the area of the container where the sensors are located. The sensors report the data to a circulation controller. The circulation controller controls the circulators distributed around and/or throughout the container. The circulation controller controls the operation of the circulators responsive to the data from the sensors. The circulation controller may increase circulation in one portion (e.g., area) of the container but not in other portions of the container thereby increasing heat transfer in one portion of the container while decreasing heat transfer in another portion.

### BRIEF DESCRIPTION OF THE DRAWING

Embodiments of the present invention will be described with reference to the figures of the drawing. The figures present non-limiting example embodiments of the present disclosure. Elements that have the same reference number are either identical or similar in purpose and function, unless otherwise indicated in the written description.

FIG. 1 is a perspective view of an example embodiment of a battery block.

FIG. 2 is a top view of the battery block of FIG. 1 with heat exchangers.

FIGS. 3-4 are front views of the battery block of FIG. 1 with heat exchangers.

FIG. 5 is a perspective view of the exterior of a battery system according to various aspects of the present disclosure.

FIG. 6 is a top view of the interior of the battery system of FIG. 5.

FIG. 7 is a perspective view of the exterior of a battery system with circulators according to various aspects of the present disclosure.

FIG. 8 is a top view of the interior of the battery system of FIG. 7.

FIG. 9 is a diagram of an embodiment of a circulator that uses a rotating magnetic field to drive the thruster.

FIG. 10 is a diagram of another embodiment of a circulator that directly drives the thruster.

FIG. 11 is a diagram of another embodiment of a circulator that uses a rotating magnetic field to drive the thruster.

### DETAILED DESCRIPTION

### Overview

An example embodiment of the present disclosure relates to battery systems. A battery system includes, among other things, a container that includes a wall that encloses a cavity, a liquid coolant positioned in the cavity of the container, and a plurality of battery cells arranged to form a plurality of battery blocks which are positioned in the cavity and at least partially submerged in the liquid coolant. A battery system may further include heat exchangers. The heat exchangers may couple to the battery blocks, an inside surface of the wall of the container and/or an outside surface of the wall of the container. The heat exchangers aid in transferring heat between a fluid medium that surrounds the exterior of the battery system and the battery blocks positioned inside the container of the battery system. The liquid coolant further aids in transferring heat between the battery blocks and the container of the battery system. The container the battery system may be sealed, so the liquid coolant may be sealed in the cavity of the container, such that the liquid coolant does not exit the container.

A battery system may further include a plurality of circulators. A circulator is configured to circulate (e.g., move, cause to flow, move around freely, move in an area) the liquid medium inside the cavity of the container of the battery system. The circulators may circulate the liquid medium to aid in the transfer of heat between the heat exchangers coupled to the battery blocks and the heat exchangers coupled to the inside surface of the wall of container or to the wall of the container itself. In an example embodiment, the thruster portion of the circulator is positioned in the cavity of the container. The thruster may be sealed inside the container. The thruster is adapted to circulate the liquid coolant inside the container. The thruster may be adapted to circulate the liquid coolant primarily in one area (e.g., region, portion) of the container. The battery blocks may be positioned inside the container with respect to the various areas of the cavity. The circulation of the liquid coolant caused by the thruster in a particular area may affect the battery blocks positioned in the same area more than the battery blocks positioned in other areas.

A battery system may further include a plurality of sensors. A sensor may be configured to capture data regarding physical properties such as temperature, electrical current, electrical voltage, an amount of a flow of the liquid coolant, and a direction of a flow of the liquid coolant. A sensor may report the data it captures.

A battery system may further include a circulation controller. The circulation controller is configured to, inter alia, receive the data from the plurality of sensors, interpret the data with respect to the various areas inside the cavity of the container, control the operation of the circulators positioned in the respective areas responsive to the data. The circulator controller may increase the circulation of the liquid coolant in one area to increase the transfer of heat. The circulation controller may decrease the circulation of the liquid coolant in another area to decrease the transfer of heat. The circulation controller may detect the operation of the battery blocks and adjust circulation in accordance with the battery blocks in one or more areas.

In an example embodiment of a circulator, thruster portion of the circulator is positioned inside the container, while the motor portion (e.g., rotor, drive mechanism) is positioned outside the container. The motor portion of the circulator may cause the thruster portion inside the container to turn, thereby causing circulation of the liquid coolant inside container. The motor of a circulator mate directly drive the thruster to circulate the liquid coolant. The motor of a circulator may indirectly drive the thruster via a rotating magnetic field.

### Battery Cell

A battery cell includes a container (e.g., case) that contains (e.g., holds) anode collectors, cathode collectors, and an electrolyte positioned between the anode collectors and the cathode collectors. Generally, the container seals the anode collectors, the cathode collectors and the electric light inside the container. The battery cell further includes an anode terminal that electrically couples to all of the anode collectors and a cathode terminal that electrically couples to all the cathodes. A portion of the anode terminal and a portion of the cathode terminal are positioned on an exterior of the battery cell. The battery cell provides an electric current via the anode terminal and the cathode terminal while discharging. The battery cell receives an electric current via the anode terminal and the cathode terminal while charging.

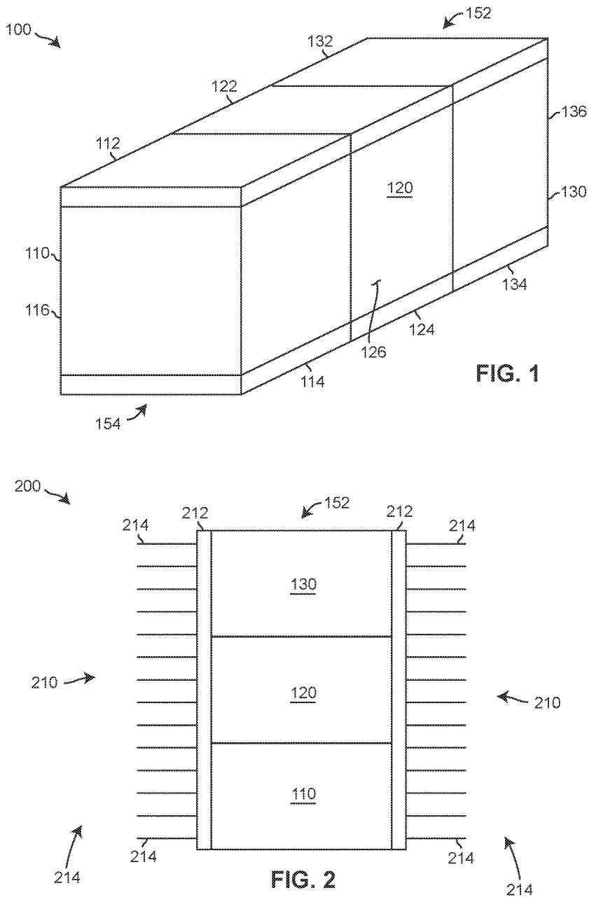

In an example embodiment, as best shown in FIGS. 1-4, battery cell 110 includes anode 112, cathode 114, and case 116. Battery cell 120 includes anode 122, cathode 124, and case 126. Battery cell 130 includes anode 132, cathode 134, and case 136. Battery cells 110, 120 and 130 form battery block 100. In example embodiment, anode 112, anode 122 and anode 132 electrically coupled to each other and cathode 114, cathode 124 and cathode 134 electrically coupled to each other thereby coupling the battery cells 110, 120 and 130 in a parallel configuration. In another example embodiment, anode 112 electrically couple to cathode 124 and anode 122 electrically coupled to cathode 134 to connect the battery cells 110, 120 and 130 in series. In an embodiment, the battery cells 110, 120 and 130 are physically bound to each other to form the battery block 100. In an example embodiment, the cases 116, 126 and 136 are physically connected.

### Battery Block

A battery block includes a plurality of battery cells, for example the battery cells 110, 120 and 130 as discussed above form the battery block 100. The battery block includes an anode terminal and a cathode terminal. The anode terminal electrically couples to at least one anode of the plurality of battery cells that form the battery block depending on whether the battery cells are connected in parallel or series. The cathode terminal electrically coupled to at least one cathode of the plurality of battery cells form the battery block depending on whether the battery cells are connected in parallel or series.

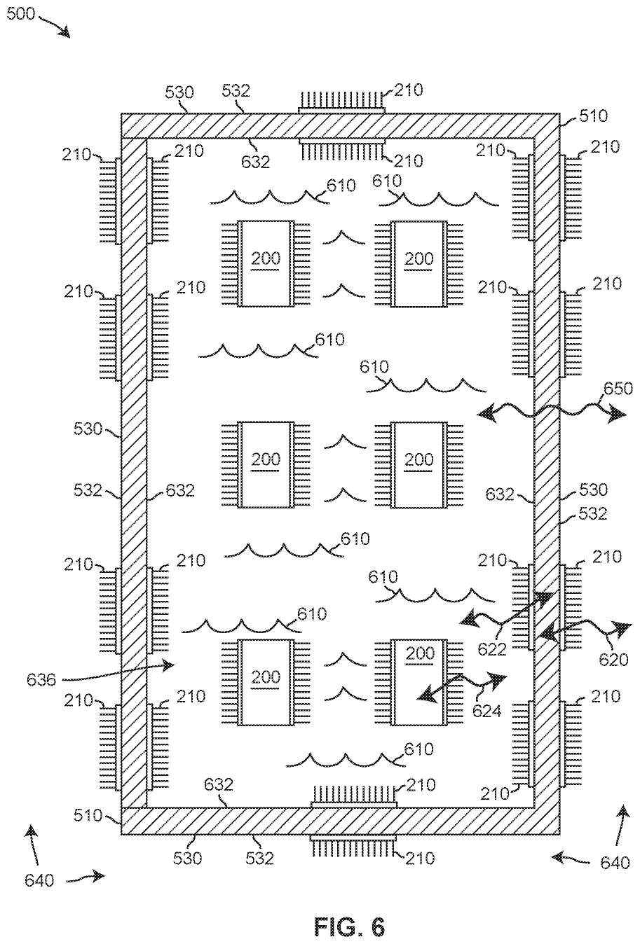

In an example embodiment, as best shown in FIGS. 1-4, 6, and 8, the battery block 100 includes the battery cells 110, 120 and 130. In an example embodiment, the anode 112, 122 and 132 are electrically connected to each other. The anode terminal 152 of the battery block 100 may electrically couple to any one or all of the anodes 112, 122 and 132. The cathodes 114, 124 and 134 are electrically connected to each other. A cathode terminal 154 of the battery block 100 may electrically couple to any one or all of the cathodes 114, 124 and 134.

A battery block may include one or more heat exchangers. In an example embodiment, a battery block 200 includes two heat exchangers 210 and the battery cells 110, 120 and 130. The heat exchangers 210 may be positioned at any location on the battery block 100 or the battery cells 110, 120 and 130. The heat exchangers 210 thermally couple to one or more of the battery cells 110, 120 and 130. The heat exchangers 210 they mechanically coupled to one or more of the battery cells 110, 120 and 130. Mechanically coupling a heat exchanger 210 to a battery cell may further thermally couple the heat exchanger 210 to the battery cell.

In an example embodiment, as best shown in FIGS. 2-4, the heat exchangers 210 thermally and mechanically couple to the sides of the battery cells 110, 120 and 130. Because the heat exchangers 210 thermally couple to the battery cells 110, 120 and 130, the heat exchangers 210 can aid in the transfer of heat from the battery cells 110, 120 and 130 to decrease the temperature of the battery cells 110, 120 and 130. The thermal coupling may further enable the heat exchangers 210 to aid in the transfer of heat to the battery cells 110, 120 and 130 to increase the temperature of the battery cells 110, 120 and 130.

The anode terminal 152 and the cathode terminal 154 of the battery block 100/200 provides an electric current while the battery block 100/200 is discharges. The anode terminal 152 and the cathode terminal 154 receive your current while the battery block 100/200 is charged.

As with the battery cells discussed above, the anode terminal 152 and the cathode terminal 154 of a plurality of battery blocks 100/200 may be coupled in parallel or in series. A battery system may include a plurality of battery blocks 100/200 that are electrically coupled in series and/or in parallel.

### Battery System

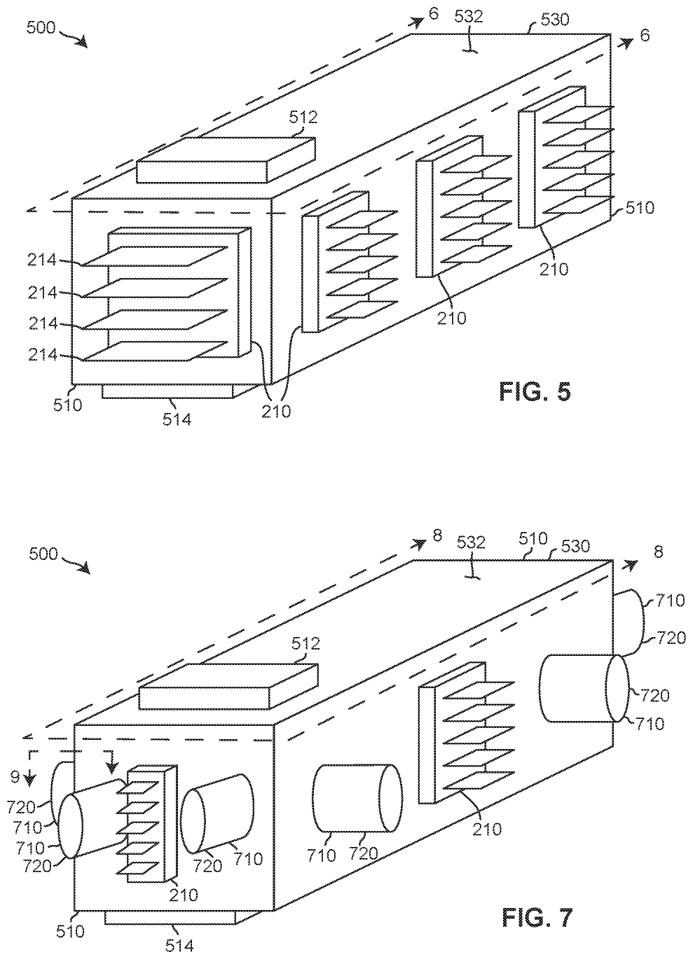

In an example implementation, a battery system 500, as best shown in FIGS. 5-8, includes a container 510, an anode terminal 512, a cathode terminal 514, a liquid coolant 610 inside the container 510, and a plurality of battery blocks 100/200 positioned inside the container 510. The anode terminals 152 and cathode terminals 154 of the battery blocks electrically coupled to the anode terminal 512 or the cathode terminal 514 of the battery system 500. As discussed above, the anode terminals 152 and the cathode terminals 154 of the battery blocks 100 may connect to each other in series and/or in parallel prior to connecting to the anode terminal 512 and the cathode terminal 514 of the battery system 500. The battery system 500 provides an electric current via the anode terminal 512 and the cathode terminal 14 of the battery system 500 while discharging and receives an electric current while charging.

In another example embodiment, the battery system 500, further includes a plurality of heat exchangers 210. The heat exchangers 210 may be thermally and mechanically coupled to the battery blocks 100 to form battery blocks 200 as discussed above, the inside surface 632 of the wall 530 of the container 510 and/or the outside surface 532 of the wall 530 of the container 510 of the battery system 500.

In an example embodiment, the plurality of heat exchangers 210 is divided into a plurality of groups. The heat exchangers 210 of a first group couple to the outside surface 532 of the wall 530. The heat exchangers 210 of a second group couple to the inside surface 632 of the wall 530. The heat exchangers 210 of a third group couple to the plurality of battery blocks 200. The heat exchangers 210 of the second group and the third group are positioned inside the cavity 636 of the container 510.

In an example embodiment, the heat exchangers 210 of the second group and of the third group are at least partially submerged in the liquid coolant 610. In another example embodiment, the heat exchangers 210 of the second group and the third group are completely submerged in the liquid coolant 610. The fluid medium 640, that surrounds the exterior of the container 510, contacts the heat exchangers 210 of the first group. In an example embodiment, the battery system 500 further includes a plurality of circulators 710. The circulators 710 circulate the liquid coolant 610 inside the container 510. Circulation of the liquid coolant 610 aids in the transfer of heat between the battery blocks 100/200 and a fluid medium 640 around the exterior of the battery system 500.

In another example embodiment, the battery system 500 further includes a plurality of circulators 710, a plurality of sensors (e.g., 812, 822, 832, 842) and a circulation controller 850. The sensors (e.g., 812, 822, 832, 842), the battery blocks 100/200, and the circulators 710 may be distributed throughout the interior (e.g., cavity 626) of the container 510 of the battery system 500. Portions of the interior of the container 510 may be referred to as an area (e.g., 810, 820, 830, 840). The sensors (e.g., 812, 822, 832, 842) positioned in an area (e.g., 810, 820, 830, 840) detect physical properties of the liquid coolant 610 and/or the one or more battery blocks 100/200 positioned in the area. In an example embodiment, at least one battery block 100/200 is positioned in each area (e.g., 810, 820, 830, 840) of the plurality of areas.

The sensors (e.g., 812, 822, 832, 842) may capture data regarding the physical properties detected. The sensors may report the captured data to the circulation controller 850. The circulation controller 850 may analyze (e.g., interpret, construe, process) the data from the sensors to determine whether the heat transfer in each area is functioning as desired. Responsive to analyzing the data, the circulation controller 850 may adjust (e.g., start, stop, increase, decrease) the operation of the one or more circulators 710 in one or more of the areas (e.g., 810, 820, 830, 840) to increase or decrease the heat transfer in the respective areas.

### Container and Liquid Coolant

In an example embodiment, the container 510 includes the wall 530. The wall 530 encloses a cavity 636. The wall 530 includes the inside surface 632 and the outside surface 532. The wall 530 is formed of a thermally conductive material. In an example embodiment, the wall 530 is formed of a thermally conductive plastic. In an example embodiment, the wall 530 is not electrically conductive, but is electrically insulating.

In an example embodiment, the liquid coolant 610 is positioned in the cavity 636 of the container 510. The wall 530 of the container 510 seals the liquid coolant 610 inside the cavity 636 whereby the liquid coolant 610 cannot exit the container 510. In an example embodiment, the liquid coolant 610 fills the cavity 636 of the container 510. The plurality of battery blocks 100/200 are positioned in the cavity 636. The plurality of battery blocks 100/200 are partially or fully submerged in the liquid coolant 610. In an example embodiment, the plurality of battery blocks 100/200 are at least partially submerged in the liquid coolant 610. In another example embodiment, the plurality of battery blocks 100/200 are completely submerged in the liquid coolant 610. The liquid coolant 610 contacts the base 212 and the fins 214 of the heat exchanger 210 coupled to the battery blocks 200.

In an example embodiment, the container 510 of the battery system 500 is surrounded by the fluid medium 640. In an embodiment, the fluid medium 640 comprises a gas, such as air. The fluid medium 640 contacts the outside surface 532 of the wall 530 of the container 510. The fluid medium 640 contacts the heat exchangers 210 of the first group, which are coupled to the outside surface 532 of the wall 530. The wall 530 is configured to transfer heat between the fluid medium 640 and the liquid coolant 610. Because the liquid coolant 610 does not exit the container 510, heat transfer between the battery blocks 100/200 and the exterior of the container 510 (e.g., to fluid medium 640) takes place via the wall 530 of the container 510. As discussed above, the wall 530 is thermally conductive.

The heat exchangers aid in the transfer of heat between the battery blocks 100/200 and the fluid medium 640. For example, the heat exchangers 210 of the third group, those that are attached to the battery blocks (e.g., battery block 200), facilitate the transfer of heat between the battery block 100 and the liquid coolant 610 as indicated by a transfer arrow 624. The heat exchangers 210 of the second group, those that are attached to the inside surface 632 of the container 510, facilitate the transfer of heat between the liquid coolant 610 and the wall 530 of the container 510 as indicated by a transfer arrow 622. The heat exchangers 210 of the first group, those that are attached to the outside surface 532 of the container 510, facilitate the transfer of heat between the wall 530 of the container 510 and the fluid medium 640 as indicated by a transfer arrow 620. Heat may also be transferred between the liquid coolant 610 and the fluid medium 640 via wall 530 as indicated by a transfer arrow 650.

The circulators, as discussed in greater detail below, circulate the liquid coolant 610 in the cavity 626 to spread heat throughout the container to facilitate its transfer to the fluid medium 640. Circulating the liquid coolant 610 reduces temperature differences of the liquid coolant throughout the cavity 626 and enables heat to evenly transfer between the liquid coolant 610 and the fluid medium 640 throughout the container 510.

### Heat Exchangers

The heat exchanger 210 may also be referred to as a heat sink. The heat exchanger 210 facilitates the transfer of heat. A heat exchanger 210 increases a surface area of the device (e.g., battery block 100, the outside surface 532, the inside surface 632) to which the heat exchanger 210 is thermally coupled. When the temperature of the device is greater than the temperature of medium surrounding device, the heat exchanger 210 increases the flow of heat away from the device. When the temperature of the medium surrounding the device is greater than the temperature of the device, the heat exchanger 210 increases the flow of heat into the device.

In the example embodiments discussed above, the heat exchangers 210 may be coupled to a battery block 100 (e.g., to form battery blocks 200), to the outside surface 532 of the wall 530, and/or to the inside surface 632 of the wall 530. As discussed above, the plurality of heat exchangers 210 may be divided into a plurality of groups. The heat exchangers 210 of the first group are configured to transfer heat between the fluid medium 640 and the wall 530 of the container 510 (see transfer arrow 620). The heat exchangers 210 of the second group are configured to transfer heat between the wall 530 of the container 510 and the liquid coolant 610 (see transfer arrow 622). The heat exchangers 210 of the third group are configured to transfer heat between the liquid coolant 610 and the plurality of battery blocks 100 (see transfer arrow 624).

In an example embodiment, a quantity of heat is transferred from the plurality of the battery blocks 100 to the liquid coolant 610 via the heat exchangers 210 of the third group. The quality of heat is transferred from the liquid coolant 610 to the wall 530 of the container 510 via the heat exchangers 210 of the second group. The quantity of heat is transferred from the wall 530 to the fluid medium 640 via the heat exchangers 210 of the first group, whereby the temperature of the plurality of the battery blocks 200 is maintained or decreases.

In an example embodiment, a quantity of heat is transferred from a fluid medium 642 the wall 530 of the container 510 by the heat exchangers 210 of the first group. The quality of heat is transferred from the wall 530 to the liquid coolant 610 via the heat exchangers 210 of the second group. The quantity of heat is transferred from the liquid coolant 610 to the plurality of battery blocks 100 via the heat exchangers 210 of the third group, whereby the temperature of the plurality of the battery blocks 100 is maintained or increases.

In an example embodiment, the heat exchangers 210 include fins 214 to facilitate the transfer of heat. The fins 214 couple to the base 212. The base 212 thermally couples to the battery block 100, to the inside surface 632 of the wall 530, or to the outside surface 532 of the wall 530 depending on the group to which the heat exchanger 210 belongs. The base 212 further mechanically couples to the battery block 100, the inside surface 632 of the wall 530, or the outside surface 532 of the wall 530. Mechanical connection establishes thermal connection. The liquid coolant 610 flows between the fins 214 of the heat exchangers 210 of the second group and the third group. The fluid medium 640 flows between the fins 214 of the heat exchangers 210 of the first group. The liquid coolant 610 and the fluid medium 640 contact the heat exchangers 210.

In an example embodiment, at least one heat exchanger 210 couples to each battery block 100 thereby forming the battery block 200. In an example embodiment, a heat exchanger 210 couples to a first side of the battery cells 110, 120 and 130 of the battery block 100. In an example embodiment, a heat exchanger 210 couples to a second side of the battery cells 110, 120 and 130 of the battery block 100. In an example embodiment, two heat exchangers 210 (e.g., first, second) thermally couple to the first side and a second side respectively of the battery cells 110, 120 and 130. In an example embodiment, two heat exchangers 210 thermally and mechanically coupled to the battery cells 110, 120 and 130.

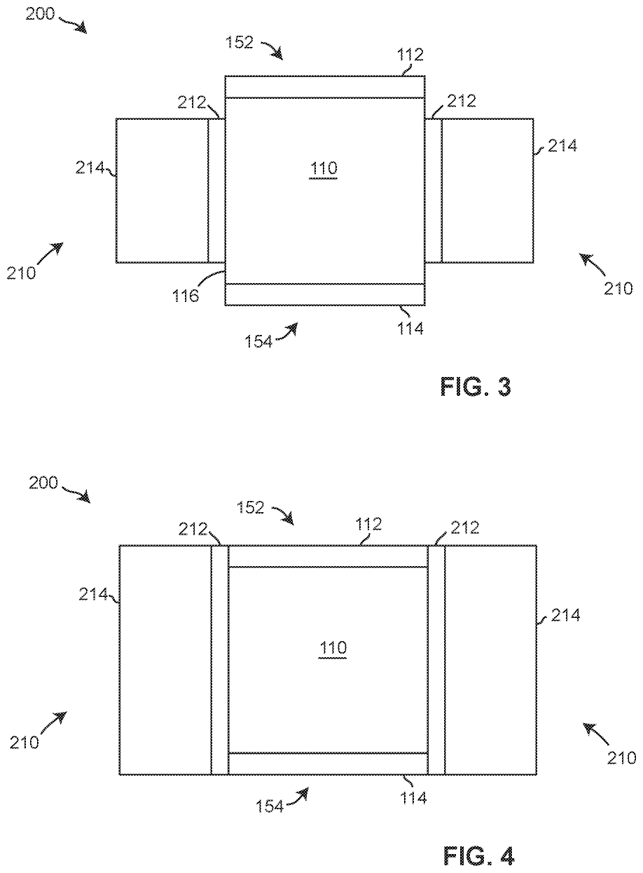

In an example embodiment, best shown in FIGS. 2-6, the base 212 and the fins 214 of the heat exchanger 210 are thermally conductive. The fins 214 are thermally and mechanically coupled to the base 212. In an example embodiment, best shown in FIG. 3, the base 212 of the heat exchanger 210 is electrically and thermally conductive. Because the base 212 is electrically conductive, so the base 212 should not contact the anode 112, 122, 132 and the cathode 114, 124, 134 of the battery cells 110, 120 and 130. In an example embodiment, best shown in FIG. 4, the base 212 of the heat exchanger 210 is not electrically conductive, but is thermally conductive, so the base 212 may contact the anode 112, 122, 132 and/or the cathode 114, 124, 134 of the battery cells 110, 120 and 130.

The liquid coolant 610 is thermally conductive. The viscosity of the liquid coolant 610 is suitable for being circulated throughout the cavity 636 of the container 510. Viscosity of the liquid coolant 610 is suitable for being circulated by a thruster 860 (e.g., impeller, propeller). In an example embodiment, the liquid coolant 610 is not electrically conductive. The fluid medium 640 is thermally conductive. In an example embodiment, the fluid medium 640 is not electrically conductive.

### Circulators

A circulator 710 circulates (e.g., moves, causes to flow) the liquid coolant 610 inside the cavity 636 of the container 510. Circulation of the liquid coolant 610 causes the liquid coolant 610 to flow around and through the fins 214 of the heat exchangers 210 of the first group and the second group. Circulation of the liquid coolant 610 facilitates the transfer of heat between the heat exchangers of the second group and the third group.

In an implementation, the circulator 710 includes a motor 720 and a thruster 860. The motor 720 drives (e.g., start, stop, increase, decrease) the thruster 860. The motor 720 drives (e.g., on) the thruster 860 to circulate the liquid coolant 610. When the motor 720 does not drive (e.g., off) the thruster 860, the thruster 860 does not circulate the liquid coolant 610. The motor 720 may cause the thruster 860 to circulate the liquid coolant 610 at different speeds (e.g., off, low, medium, high). The speed of circulation provided by the thruster 860 may be referred to as its rate of circulation or volume of circulation. To circulate the liquid coolant 610, the thruster 860 may intake the liquid coolant 610 through an inlet and expel the liquid coolant 610 through an outlet. The outlet may be oriented in a direction. The direction of the orientation of the outlet to be changed.

In an embodiment, the circulator 710 is positioned inside the cavity 636 of the container 510. In this embodiment, the circulator 710 is partially or completely submerged in the liquid coolant 610. In another embodiment, the motor 720 of the circulator 710 is positioned outside the container 510 and the thruster 860 is positioned inside the cavity 636. In this embodiment, the thruster 860 is partially or completely submerged in the liquid coolant 610. The thruster 860 may be implemented as an impeller or a propeller.

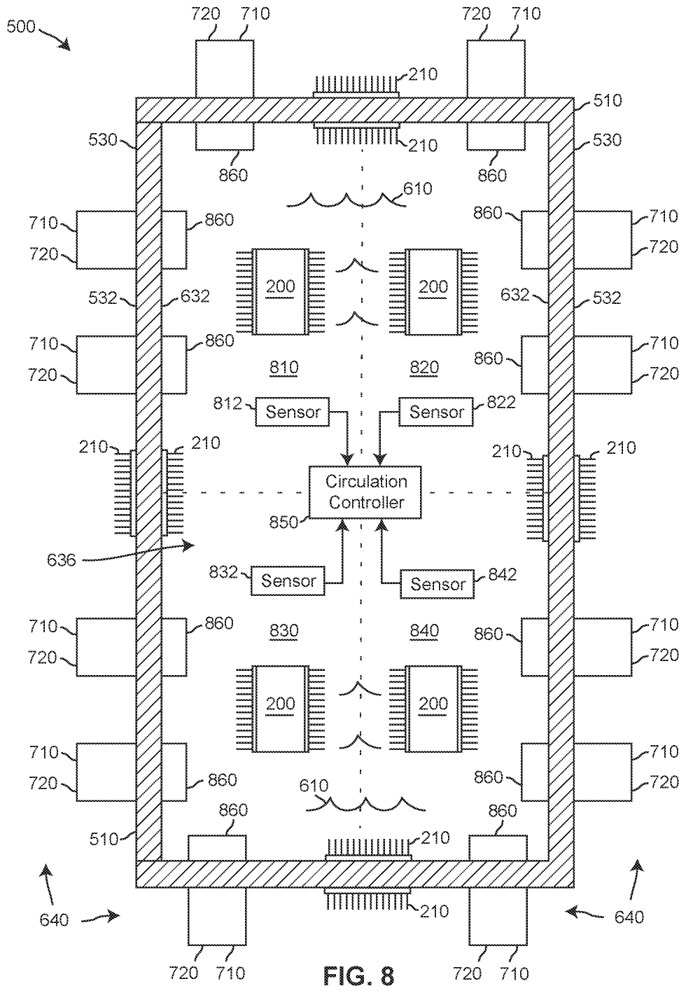

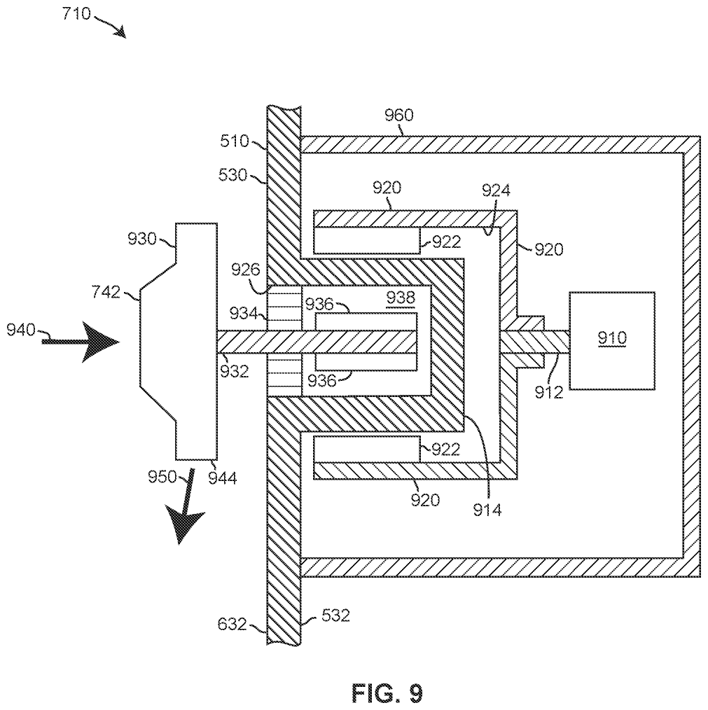

Regardless of whether the circulator 710 is positioned inside the cavity 636 or whether the motor 720 of the circulator 710 is positioned outside the container 510 and the thruster 860 is positioned inside the cavity 636, the container 510 is sealed so that the liquid coolant remains inside the cavity 636 and does not exit (e.g., cannot leave) the container 510. In an example embodiment, a shaft of the motor 720 extends through the wall 530 of the container 510 to drive the thruster 860. A seal between the shaft and the wall 530 seals the container 510 to keep the liquid coolant 610 inside the cavity 636. In another example embodiment, as best shown in FIG. 8, the motor 720 is positioned outside the container 510 and uses a magnetic field to drive the thruster 860, so that the wall 530 is not pierced for the motor 720 to drive the thruster 860.

The motor 720 may be controlled by the circulation controller 850. The circulation controller 850 may control the motor 720 via a wired and/or a wireless communication link. The circulation controller 850 may control the motors 720 of the plurality of circulators 710. The circulation controller 850 may individually control each circulator 710, so that each circulator 710 circulates the liquid coolant at a different rate. The circulation controller 850 may control the direction of the orientation of the outlet of each circulator 710. The circulation controller 850 may individually control the rate of circulation and/or the direction of circulation of each circulator 710 of the battery system 500. Accordingly, the circulation controller 850 may control the flow of the liquid coolant 610 in one or more areas (e.g., 810, 820, 830, 840) of the container 510 of the battery system 500.

In an example embodiment, the battery system 500 includes at least one circulator 710. In an example embodiment, the battery system 500 is divided into a plurality of areas (e.g., 810, 820, 830, 840). At least one circulator 710 is positioned in each area. In an example embodiment, the at least one circulator 710 positioned in a particular area predominantly controls the flow of the liquid coolant 610 in the particular area. While the circulator 710 in a different area may cause some liquid coolant 610 to flow in the particular area, the majority of the flow of the liquid coolant 610 in the particular area is caused by the at least one circulator 710 positioned in the particular area.

For example, in an example embodiment, best shown in FIG. 8, the cavity 636 of the container 510 is divided into area 810, area 820, area 830 and area 840. The thruster 860 of the two circulators 710 are positioned in each area 810, 820, 830 and 840. The two circulators 710 in each area control a majority of the flow of the liquid coolant 610 in the area. One or more battery blocks 200 are positioned in each area 810, 820, 830 and 840.

In an example embodiment, the battery system 500 includes the plurality of circulators 710. The plurality of circulator 710 are positioned inside the cavity 636 of the container 510. The plurality of circulators 710 are configured to circulate the liquid coolant 610 inside the cavity 636 of the container 510. At least one circulator 710 of the plurality of circulators 710 is positioned in each area of the plurality of areas (e.g., 810, 820, 830, 840). The at least one circulator 710 positioned in each area is configured to circulate the liquid coolant 610 in that area. Various embodiments of the circulator 710 are discussed below.

### Sensors

In an example embodiment, the battery system 500 includes a plurality of sensors (e.g., 812, 822, 832, 842). The sensors of the plurality of sensors are positioned inside the cavity 636 of the container 510. A sensor may be submerged or partially submerged in the liquid coolant 610 At least one sensor of the plurality of sensors (e.g., 812, 822, 832, 842) is positioned in each area of the plurality of areas (e.g., 810, 820, 830, 840). For example, the sensors 812, 822, 832 and 842 are positioned in the areas 810, 820, 830 and 840 respectively.

A sensor is configured to detect physical properties (e.g., temperature, circulation, current, voltage). The sensor is configured to capture data regarding the physical properties it detects. Since the sensors and the battery blocks may be positioned in an area. In an example embodiment, each sensor is configured to capture data regarding the liquid coolant 610 and/or the battery block 200 positioned in the area in which the sensor is positioned. The sensor (e.g., 812, 822, 832, 842) in the area (e.g., 810, 820, 830, 840) may capture data regarding the temperature of the liquid coolant 610 in the area, the temperature of the at least one battery block 100/200 positioned in the area, the amount of current provided by the at least one battery block 100/200 positioned in the area, the amount of current drawn by the at least one battery block 100/200 positioned in the area, the voltage provided by (e.g., across) the at least one battery block 100/200 positioned in the area, the rate of flow of the liquid coolant 610 in the area, and/or the direction of the flow of the liquid coolant 610 in the area.

In an example embodiment, the sensors 812, 822, 832 and 842 capture data regarding the liquid coolant 610 and/or the battery block 200 in the areas 810, 820, 830 and 840 respectively. For example, the sensor 812 captures data regarding the temperature of the liquid coolant 610, the temperature of the battery block 200, the amount of current provided by the battery block 200, the amount of current drawn by the battery block 200, the voltage provided by (e.g., across) the battery block 200, the rate of flow of the liquid coolant 610, and/or the direction of the flow of the liquid coolant 610 in the area 810. The sensors 812, 832 and 842 perform the same functions for the areas 820, 830 and 840 respectively.

The sensor (e.g., 812, 822, 832, 842) is configured to provide the data it captures to the circulation controller 850. The sensor may provide the data it captures to the circulation controller 850 via a wired and/or a wireless communication link.

The sensor (e.g., 812, 822, 832, 842) may include a plurality of sensors that measure different physical properties or the same physical properties, but positioned at different locations within the area 820.

### Circulation Controller

The circulation controller 850 is configured to receive data from the plurality of sensors (e.g., 812, 822, 832, 842). The data from the plurality of sensors may be in any format (e.g., digital, analog) and may be provided continuously or at intervals. The circulation controller 850 may include a processing circuit (e.g., microprocessor, microcontroller, signal processor) for interpreting, manipulating and/or performing calculations on the data it receives from the plurality of sensors. The circulation controller 850 may include a memory for storing a program executed by the processing circuit and/or the data received from the plurality of sensors.

In an example embodiment, as discussed above, at least one sensor of the plurality of sensors (e.g., 812, 822, 832, 842), at least one battery block 200 of the plurality of battery blocks, and at least one circulator 710 of the plurality of circulators is positioned in each area of the plurality of areas (e.g., 810, 820, 830, 840). The circulation controller 850 is configured to receive the data from each sensor of the plurality of sensors. The circulation controller 850 is configured to control the operation of the at least one circulator 710 positioned in each area respectively responsive to the data captured by the at least one sensor positioned in each area respectively.

In an example embodiment, the circulation controller 850 is configured to increase an amount of flow of the liquid coolant 610 provided by the at least one circulator 710 positioned in a particular area (e.g., 810, 820, 830, 840) responsive to the at least one sensor positioned in the particular area detecting an increase in a temperature of the at least one battery block or the liquid coolant 610 positioned in the particular area. The circulation controller 850 is further configured to decrease an amount of flow of the liquid coolant 610 provided by the at least one circulator 710 positioned in the particular area responsive to the at least one sensor positioned in the particular area detecting a decrease in the temperature of the at least one battery block 200 or the liquid coolant 610 positioned in the particular area.

The circulation controller 850 is further configured to increase amount of flow of the liquid coolant 610 provided by the at least one circulator 710 positioned in a particular area (e.g., 810, 820, 830, 840) responsive to the at least one sensor positioned in the particular area detecting an increase in an amount of current drawn by the at least one battery block 200 positioned in the particular area. The increase in the amount of current drawn by the at least one battery block 200 may indicate that more current is being drawn from or provided to the battery block 200, so the temperature of the battery block 200 is likely to increase. The increase in the amount of current drawn by the at least one battery block 200 may also indicate a fault in one of the battery blocks 200 that has resulted in a short in the battery block 200 which will increase the temperature of the battery block 200 until it is fully discharged.

The circulation controller 850 is further configured to increase an amount of flow of the liquid coolant 610 provided by the at least one circulator 710 positioned in a particular area (e.g., 810, 820, 830, 840) responsive to the at least one sensor positioned in the particular area detecting a decrease in the voltage provided by the at least one battery block 200 positioned in the particular area. The decrease in voltage of the battery block 200 may be an indication that more current is being drawn from the battery block 200 or that the battery block 200 has shorted out and will fail. In either case, the temperature of the battery block 200 will likely rise.

For example, the circulation controller 850 is configured to receive data from the sensor 822, which is positioned in the area 820. Two circulators 710 are also positioned to circulate the liquid coolant 610 primarily in the area 820. Although the circulators 710 in the areas 810 and 840 may affect the circulation of the liquid coolant 610 in the area 820, the two circulator 710 whose thrusters 860 are positioned in area 820 have the greatest effect on the flow of the liquid coolant 610 in area 820. The sensor 822 detects and captures data regarding the liquid coolant 610 and the battery block 200 in the area 820. There may be more than one battery block 220 positioned in the area 820.

The sensor 822 may be in physical contact with one or more of the battery cells (e.g., 110, 120, 130) of the battery block 200 to detect the temperature of the battery block 200. The sensor 822 may be in electrical contact with the anode terminal 512 and/or the cathode terminal 514 to detect the current provided by the battery block 200 or the current sunk by the battery block 200. The sensor 822 may be in electrical contact with the anode terminal 512 and/or the cathode terminal 514 to detect the voltage across the battery block 200. The sensor 822 may be in electrical contact with some or all of the anodes 112, 122 and 132 or the cathodes 114, 124 and 134 of the battery cells 110, 120 and 130 respectively that comprise the battery block 200. The sensor 822 may detect the currents provided or sunk and the voltage across the individual battery cells 110, 120 and 130 of the battery block 200.

The sensor 822 may detect the rate of flow of the liquid coolant 610 in the area 820. The sensor 822 may the flow (e.g., 950) out each outlet (e.g., 944) of each circulator 710 positioned in the area 820. The sensor 822 may detect the direction of flow of the liquid coolant 610 within, into and/or out of the area 820. In accordance with the data received from the sensor 822, the circulation controller 850 may control the operation of any circulator 710 of any area (e.g., 810, 820, 830, 840), including primarily the area 820, to decrease, maintain or increase the temperature of the battery block 200 positioned in the area 820.

In an example embodiment, the circulation controller 850 is configured to receive the data from the plurality of sensors (e.g., 812, 822, 832, 842). The circulation controller 850 is configured to control the operation of the least one circulator 710 positioned in each area (e.g., 810, 820, 830, 840) respectively responsive to the data captured by the at least one sensor (e.g., 812, 822, 832, 842) positioned in each area (e.g., 810, 820, 830, 840) respectively.

In an example embodiment, the circulation controller 850 is configured to increase or decrease an amount of flow (e.g., rate of flow) provided by the at least one circulator 710 positioned in a particular area (e.g., 810, 820, 830, 840) responsive to the least one sensor (e.g., 812, 822, 832, 842) positioned in the particular area detecting an increase or a decrease respectively in a temperature of the at least one battery block 200 positioned in the particular area.

In an example embodiment, the circulation controller 850 is configured to increase an amount of flow (e.g., rate of flow) provided by the at least one circulator 710 positioned in a particular area (e.g., 810, 820, 830, 840) responsive to the least one sensor (e.g., 812, 822, 832, 842) positioned in the particular area detecting an increase in an amount of current drawn or a decrease in the voltage provided respectively by the at least one battery block 200 positioned in the particular area.

### First Embodiment of a Circulator

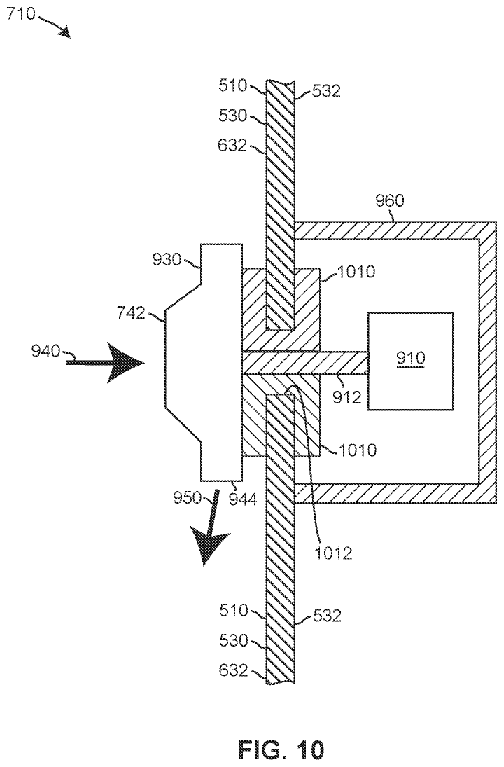

In a first example embodiment, the circulator 710 includes a motor 910, a case 960, a seal 1010 and an impeller 930. As best seen in FIG. 10, the case 960, the wall 530, and the seal 1010 are shown in cross section to highlight the sealing of the container 510 and how the motor 910 drives the impeller 930. The motor 910 and the impeller 930 are not shown in cross-section because their functions are understood without showing the details of their cross-sections.

The seal 1010 is positioned in opening 1012 (e.g., hole) made in the wall 530 of the container 510 so that the shaft 912 of the motor 910 may pass from the outside of the container 510 to the inside of the container 510. The seal seals around the outside surface 532 of the wall 530, the opening 1012, the inside surface 632 of the wall 530 and the shaft 912 to retain the liquid coolant 610 inside the cavity 636 of the container 510. The seal 1010 stops the liquid coolant 610 from exiting the container 510. The case 960 encloses the motor 910 to protect it from the elements. The motor 910 may be controlled by the circulation controller 850.

The motor 910 corresponds to the motor 720 and the impeller 930 corresponds to the thruster 860 discussed above. Because the impeller 930 corresponds to thruster 860, the impeller 930 may be replaced with a propeller or any other type of device suitable for circulating the liquid coolant 610.

The shaft 912 of the motor 910 drive the blades (not shown) of the impeller 930 to caused the blades to rotate. The shaft 912 may rotate at different speeds under the control of the circulation controller 850. Rotation of shaft 912 and thereby rotation of the blades of the impeller 930 causes a flow 940 of the liquid coolant 610 to enter the inlet 942 of the impeller 930. The blades of the impeller 930 force the liquid coolant 610 to flow out the outlet 944 of the impeller 930 as a flow 950. The rate (e.g., volume) of the flow 940 and the flow 950 depends on (e.g., is proportional to) the speed of rotation of the shaft 912 and thereby by the speed of rotation of the blades of the impeller 930. The outlet 944 may be oriented in any direction. In another example embodiment, the impeller 930 may be replaced with a propeller that pushes the liquid coolant 610 in accordance with the speed of rotation of the shaft 912.

### Second Embodiment of a Circulator

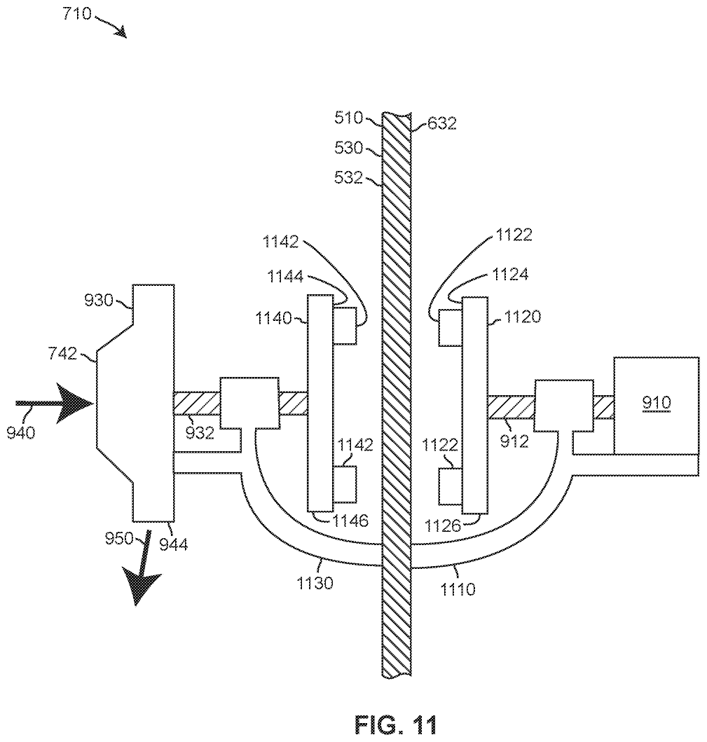

In a second example embodiment, as best seen in FIG. 11, the circulator 710 includes the motor 910, the impeller 930 an outer support 1110, an outer base 1120, outer magnets 1122, an inner support 1130, an inner base 1140, and inner magnets 1142. The motor 910 corresponds to the motor 720 and the impeller 930 corresponds to the thruster 860 as discussed above. The impeller 930 may be replaced with a propeller or any other type of device suitable for circulating the liquid coolant 610.

The outer support 1110 positions and supports the motor 910 and the outer base 1120 on the outside of the container 510. The outer support 1110 does not pierce the wall 530 of the container 510. The outer base 1120 includes the outer magnets 1122. The outer magnets 1122 are coupled to the outer base 1120. The shaft 912 of the motor 910 couples to the outer base 1120. The inner support 1130 positions and supports the inner base 1140 and the impeller 930 on the inside of the container 510. The inner support 1130 does not pierce the wall 530 of the container 510. The inner base 1140 includes the inner magnets 1142. The inner magnets 1142 are coupled to the inner base 1140. The shaft 932 couples to the inner base 1140 and to the blades of the impeller 930. Rotating the shaft 932 rotates the blades of the impeller 930 causing the impeller to draw the liquid coolant 610 into the inlet 942 as the flow 940 and to expel the liquid coolant 610 out the outlet 944 as the flow 950.

The motor 910 rotates the shaft 912, which rotates the outer base 1120 and the outer magnets 1122. Rotation of the outer magnets 1122 induces a rotating magnetic field that penetrates the wall 530 of container 510 to present the rotating magnetic field inside the cavity 363 of the container 510. The rotating magnetic field interacts with the inner magnets 1142. The interaction of the rotating magnetic field with the inner magnets 1142 causes a force to act on the inner magnets 1142 that rotates the inner magnets 1142 and the inner base 1140. Rotation of the inner base 1140 causes the shaft 932 to rotate and in to turn the blades of the impeller 930. Rotation of the blades of the impeller 930 results in the flow 940 and the flow 950.

Because the outer support 1110 and the inner support 1130 do not pierce the wall 530 of the container 510 and because the magnetic field passes through the wall 530, there are no holes or openings in the wall 530, so the liquid coolant 610 cannot exit the container 510. Having the outer magnets 1122 induce a rotating magnetic field on the inside of the container 510 to drive the impeller 930 preserves the integrity of the wall 530 of the container 510 to retain the liquid coolant 610 in the cavity 363.

As with the first embodiment, the impeller 930 may be replaced with a propeller. Further in this embodiment, only the wall 530 is shown in cross-section to highlight that the magnetic field crosses the wall 530 without disturbing the integrity of the wall 530.

In an example embodiment of a battery system 500 with a magnetically driven thruster 860, the battery system 500 includes the container 510, the liquid coolant 610, and the circulator 710. The container 510 includes the wall 530 that encloses the cavity 636. The liquid coolant 610 is positioned in the cavity 636 of the container 510. The wall 530 of the container 510 seals liquid coolant 610 inside the container 510. The liquid coolant 610 cannot exit from the container 510. The circulator 710 includes the motor 910, the outer base 1120, the plurality of outer magnets 1122, the inner base 1140, and the plurality of inner magnets 1142. The motor 910 includes the shaft 912. The outer base 1120 is configured to couple to the shaft 912. The plurality of outer magnets 1122 are coupled to the outer base 1120. The outer base 1120 and the outer magnets 1122 are positioned proximate to the wall 530. A rotation of the shaft 912 by the motor 910 rotates the outer base 1120 and the plurality of outer magnets 1122 thereby inducing a rotating magnetic field in the interior of the container 510. The thruster 860 includes the shaft 932. The thruster 860 is positioned inside the container 510. The thruster 860 is at least partially submerged in the liquid coolant 610. The plurality of inner magnets 1142 are coupled to the inner base 1140. The inner base 1140 is coupled to the shaft 932. The rotating magnetic field interacts with the inner magnets 1142 through the wall 530 to cause the inner magnets 1142 and the shaft 932 rotate. Rotation of the shaft 932 causes the thruster 860 to circulate the liquid coolant 610 in the container 510.

In an example embodiment, the thruster 860 is partially immersed in the liquid coolant 610. In another example embodiment, the thruster 860 is completely immersed in the liquid coolant 610. In each embodiment, the thruster 860 is positioned on the inside of the container 510.

In an example embodiment, the thruster 860 comprises a propeller. The propeller includes a plurality of blades. Rotation of the shaft 932 causes the plurality of blades of the propeller to push against the liquid coolant 610 to circulate the liquid coolant 610 in the container 510.

In another example embodiment, the thruster 860 comprises the impeller 930. The impeller includes the inlet 942, the outlet 944, and the shaft 932. Rotation of the shaft 932 causes the impeller 930 to draw the liquid coolant 610 into the inlet 942 and to expel the liquid coolant 610 out the outlet 944 thereby circulating the liquid coolant 610 in the container 510.

An example embodiment, the outer magnets 1122 are coupled to the outer base 1120 on a surface 1124 of the outer base 1120. The surface 1124 of the outer base 1120 is positioned proximate to the wall 530 of the container 510. The outer magnets 1122 are positioned between the surface 1124 of the outer base 1120 and the outside surface 532 of the wall 530. In another example embodiment, the outer magnets 1122 are coupled to the outer base 1120 on an edge 1126 of the outer base 1120. The surface 1124 of the outer base 1120 is positioned proximate to the outside surface 532 of the wall 530 of the container 510.

An example embodiment, the inner magnets 1142 are coupled to the inner base 1140 on a surface 1144 of the inner base 1140. The surface 1144 of the inner base 1140 is positioned proximate to the wall 530 of the container 510. The inner magnets 1142 are positioned between the surface 1144 of the inner base 1140 and the inside surface 632 of the wall 530. In another example embodiment, the inner magnets 1142 are coupled to the inner base 1140 on an edge 1146 of the inner base 1140. The surface 1144 of the inner base 1140 is positioned proximate to the outside surface 532 of the wall 530 of the container 510.

In an example embodiment, the outer magnets 1122 are coupled to the surface 1124 of the outer base 1120 and the inner magnets 1142 are coupled to the edge 1146 of the inner base 1140. In another example embodiment, the outer magnets 1122 are coupled to the edge 1126 of the outer base 1120 and the inner magnets 1142 are coupled to the surface 1144 of the inner base 1140. In another example embodiment, the outer magnets 1122 are coupled to the edge 1126 of the outer base 1120 and the inner magnets 1142 are coupled to the edge 1146 of the inner base 1140.

The outer magnets 1122 and the inner magnets 1142 may be integrated into the outer base 1120 and the inner base 1140 respectively. In another example embodiment, the outer base 1120 is omitted and the outer magnets 1122 are positioned around the shaft 912. In another example embodiment the inner base 1140 is omitted and the inner magnets 936 are positioned around the shaft 932.

### Third Embodiment of a Circulator

In a third example embodiment, the circulator 710 includes the motor 910, the rotor 920, the outer magnets 922, the inner magnets 936 and thruster 860, which in this example embodiment is impeller 930. The rotor 920 is adapted to be coupled to the shaft 912 of the motor 910. Rotation of the shaft 912 rotates the rotor 920. The outer magnets 922 are coupled to an interior of the rotor 920. In an example embodiment, the outer magnets 922 are coupled to an inner surface 924 of the rotor 920 around an inner circumference of the rotor 920. The impeller 930 includes the shaft 932. Rotating the shaft 932 rotate the blades of the impeller 930 causing the impeller to draw the liquid coolant 610 into the inlet 942 as the flow 940 and to expel the liquid coolant 610 out the outlet 944 as the flow 950. The inner magnets 936 are coupled to the shaft 932. In an example embodiment, the inner magnets 936 are coupled around an outer circumference of the shaft 932.

The wall 530 of the container 510 includes a protrusion 914. In an example embodiment, the protrusion 914 is cylindrical in shape. The protrusion 914 does not pierce the wall 530 so the integrity of the container is maintained to retain the liquid coolant 610 inside the cavity 636. An opening 926 of the protrusion 914 is open to the cavity 636.

The inner magnets 936 and a portion of the shaft 932 are positioned in an interior 938 of the protrusion 914. A bearing 934 may be positioned in the opening 926 to receive and support the shaft 932. The bearing 934 facilitates rotation of the shaft 932 and the inner magnets 936. The inner circumference of the rotor 920 and the inner magnets 936 are positioned around an outer circumference of the protrusion 914. Rotation of the motor 910 rotates the rotor 920 and the outer magnets 922 around the protrusion 914. Rotation of the rotor 920 and the outer magnets 922 around the protrusion 914 induces a rotating magnetic field in the interior 938 of the protrusion 914. The rotating magnetic field interacts with the inner magnets 936. The interaction exerts a force on the inner magnets 936 that causes the inner magnets 936, and the shaft 932 to which the inner magnets 936 are connected, to rotate.

Rotation of the shaft 932 causes the impeller 930 to intake the liquid coolant 610 as the flow 940 into inlet 942 and to expel the liquid coolant 610 as the flow 950 out the outlet 944. The flow 940 and the flow 950 results in circulation of the liquid coolant inside the cavity 636 of the container 510. As discussed above, the outlet may be oriented to direct the flow 950 in any direction. The case 960 encloses the motor 910, the rotor 920 and the outer magnets 922. The case 960 may connect to the container 510; however, the case does not pierce the container 510. The motor 910 may be controlled by the circulation controller 850.

In another example embodiment of a battery system 500 with a magnetically driven thruster 860, the battery system 500 includes the container 510, the liquid coolant 610, and the circulator 710. The container 510 includes the wall 530 that encloses a first cavity 636. The wall 530 includes a protrusion 914 formed of wall 530 of the container 510. The interior 938 of the protrusion 914 includes a second cavity. The second cavity is open to the first cavity 636 via the opening 926. The liquid coolant 610 is positioned in the first cavity 636. The wall 530 of the container 510 seals the liquid coolant 610 inside the container 510 whereby the liquid coolant 610 cannot exit from the container 510.

The circulator 710 includes the motor 720, a rotor 920, a plurality of outer magnets 922, a thruster 860, and a plurality of inner magnets 936. The rotor 920 is configured to couple to the motor 720. The plurality of outer magnets 922 are coupled to an interior of the rotor 920. The rotor 920 and plurality of outer magnets 922 are positioned around an exterior of the protrusion 914. A rotation of the motor 720 rotates the rotor 920 and the plurality of outer magnets 922 around the exterior of the protrusion 914 thereby inducing a rotating magnetic field in the interior 938 of the protrusion 914. The thruster 860 includes an inlet 942, and outlet 944 and a shaft 932. The thruster 860 is positioned in the first cavity 636 and is submersed in the liquid coolant 610.

The plurality of inner magnets 936 are coupled to the shaft 932 of the thruster 860. A portion of the shaft 932 of the thruster 860 and the plurality of inner magnets 936 are positioned in the second cavity. The rotating magnetic field interacts with the plurality of the inner magnets 936 through the wall 530 of the container 510 to cause the plurality of inner magnets 936 and the shaft 932 of the thruster 860 to rotate. Rotation of the shaft 932 of the thruster 860 causes the thruster 860 to draw the liquid coolant 610 into the inlet 942 and to expel the liquid coolant 610 out the outlet 944 thereby circulating the liquid coolant 610 in the first cavity 636.

In an example embodiment, the thruster 860 comprises the impeller 930. In another example embodiment, the thruster 860 comprises a propeller. In an example embodiment, the motor 720 comprises an electric motor adapted to be controlled by the circulation controller 850. In example embodiment, the outer magnets 922 are coupled around a circumference of the interior of the rotor 920. In another example embodiment, the outer magnets 922 are coupled to the inner surface 924 of the inner circumference of the rotor 920. In an example embodiment, the inner magnets are coupled around a circumference of the shaft 932 of the thruster 860.

In an example embodiment, the protrusion 914 has a cylindrical shape. In an example embodiment, the interior of the rotor 916 has a cylindrical shape. The inner diameter of the rotor 916 and the outer magnets 922 is greater than the outer diameter of the protrusion 914.

### Fourth Embodiment of a Circulator

In a fourth example embodiment, the circulator 710 includes the motor 720 and the thruster 860. The motor 720 drives the thruster 860. The motor 720 and the thruster are adapted to be positioned inside the cavity 636 and submerged in the liquid coolant 610. The motor 720 is electrically coupled to the circulation controller 850. The circulation controller 850 controls the operation of the motor 720 and thereby the flow 940 into the thruster 860 and the flow 950 out from the thruster 860. The motor 720 and/or the thruster 860 may be coupled to the wall 530 of the container 510 without piercing the wall 530 of the container 510, thereby retaining the liquid coolant 610 inside the cavity 636 of the container 510.

### Afterword and Note Regarding Workpieces

The foregoing description discusses implementations (e.g., embodiments), which may be changed or modified without departing from the scope of the present disclosure as defined in the claims. Examples listed in parentheses may be used in the alternative or in any practical combination. As used in the specification and claims, the words ‘comprising’, ‘comprises’, ‘including’, ‘includes’, ‘having’, and ‘has’ introduce an open-ended statement of component structures and/or functions. In the specification and claims, the words ‘a’ and ‘an’ are used as indefinite articles meaning ‘one or more’. While for the sake of clarity of description, several specific embodiments have been described, the scope of the invention is intended to be measured by the claims as set forth below. In the claims, the term “provided” is used to definitively identify an object that is not a claimed element but an object that performs the function of a workpiece. For example, in the claim “an apparatus for aiming a provided barrel, the apparatus comprising: a housing, the barrel positioned in the housing”, the barrel is not a claimed element of the apparatus, but an object that cooperates with the “housing” of the “apparatus” by being positioned in the “housing”.

The location indicators “herein”, “hereunder”, “above”, “below”, or other word that refer to a location, whether specific or general, in the specification shall be construed to refer to any location in the specification whether the location is before or after the location indicator.

Methods described herein are illustrative examples, and as such are not intended to require or imply that any particular process of any embodiment be performed in the order presented. Words such as “thereafter,” “then,” “next,” etc. are not intended to limit the order of the processes, and these words are instead used to guide the reader through the description of the methods.

What is claimed is:

1. A battery system comprising:
a container, wherein the container includes a wall that encloses a cavity, wherein the wall includes an inside surface and an outside surface, wherein the wall is formed of a thermally conductive material;
a liquid coolant positioned in the cavity of the container;
a plurality of battery blocks positioned in the cavity, wherein the plurality of battery blocks is submerged in the liquid coolant; and
a plurality of heat exchangers, wherein the plurality of heat exchangers are divided into a plurality of groups, wherein the heat exchangers of a first group couple to the outside surface of the wall, wherein the heat exchangers of a second group couple to the inside surface of the wall, wherein the heat exchangers of a third group couple to the plurality of battery blocks, wherein the heat exchangers of the second group and the third group are positioned inside the cavity and are submersed in the liquid coolant, wherein a fluid medium contacts the heat exchangers of the first group, wherein the heat exchangers of the first group are configured to transfer heat between the fluid medium and the wall of the container, wherein the heat exchangers of the second group are configured to transfer heat between the wall of the container and the liquid coolant, and wherein the heat exchangers of the third group are configured to transfer heat between the liquid coolant and the plurality of battery blocks.

2. The battery system of claim 1 wherein the liquid coolant is configured to transfer heat between the heat exchangers of the third group and the heat exchangers of the second group.

3. The battery system of claim 1 wherein the wall is configured to transfer heat between the liquid coolant and the fluid medium.

4. The battery system of claim 1 wherein the liquid coolant cannot directly heat to or from the fluid medium, but transfers heat to or from the fluid medium via the wall or to or from the fluid medium via the heat exchangers of the first group, the wall, and the heat exchangers of the second group.

5. The battery system of claim 1 wherein the wall of the container seals the liquid coolant inside the cavity whereby the liquid coolant cannot exit the container.

6. The battery system of claim 1 wherein a quantity of heat is transferred from the plurality of battery blocks to the liquid coolant via the heat exchangers of the third group, the quantity of heat is transferred from the liquid coolant to the wall of the container via the heat exchangers of the second group, and the quantity of heat is transferred from the wall of the container to fluid medium via the heat exchangers of the first group, whereby a temperature of the plurality of battery blocks is maintained or decreases.

7. The battery system of claim 1 wherein a quantity of heat is transferred from the fluid medium to the wall of the container by the heat exchangers of the first group, the quantity of heat is transferred from the wall of the container to the liquid coolant via the heat exchangers of the second group, and the quantity of heat is transferred from the liquid coolant to the plurality of battery blocks via the heat exchangers of the third group, whereby a temperature of the plurality of the battery blocks is maintained or increases.

8. The battery system of claim 1 further comprises at least one circulator for circulating the liquid coolant inside the cavity.

9. The battery system of claim 1 wherein the heat exchangers include a plurality of fins to facilitate transfer of heat.

10. The battery system of claim 9 wherein the liquid coolant flows between the plurality of fins of the heat exchangers of the second group and the third group.

11. The battery system of claim 9 wherein the fluid medium flows between the plurality of fins of the heat exchangers of the first group.

12. The battery system of claim 1 wherein the fluid medium comprises air.

13. The battery system of claim 1 wherein at least one heat exchanger of the third group couples to each battery block of the plurality of battery blocks.

14. A battery system comprising:
a container, wherein the container includes a wall that encloses a cavity, wherein the cavity includes a plurality of areas;
a liquid coolant positioned in the cavity of the container;
a plurality of battery blocks positioned in the cavity, wherein the plurality of battery blocks is submerged in the liquid coolant, wherein at least one battery block of the plurality of battery blocks is positioned in each area of the plurality of areas;
a plurality of circulators, wherein the plurality of circulators are configured to circulate the liquid coolant inside the cavity of the container, wherein at least one circulator of the plurality of circulators is configured to circulate the liquid coolant in each area of the plurality of areas;
a plurality of sensors, wherein the plurality of sensors is positioned inside the cavity of the container, wherein at least one sensor of the plurality of sensors is positioned in each area of the plurality of areas, wherein each sensor is configured to capture data regarding at least one of the liquid coolant and the at least one battery block positioned in the area in which each sensor is positioned;
a circulation controller configured to:
receive the data from the plurality of sensors; and
control an operation of the at least one circulator responsive to the data captured by the at least one sensor positioned in each area respectively.

15. The battery system of claim 14 wherein each circulator of the plurality of circulators includes:
a motor positioned outside the container;
a thruster positioned inside the container and submerged in the liquid coolant;
a plurality of outer magnets, the plurality of outer magnets is positioned outside of the container and is coupled to the motor, whereby the motor rotates the outer magnets to induce a rotating magnetic field inside the cavity; and
a plurality of inner magnets, the plurality of inner magnets is positioned inside the container and is coupled to a shaft of the thruster, whereby responsive to the rotating magnetic field, the inner magnets rotate the shaft of the thruster to circulate the liquid coolant in the cavity.

16. The battery system of claim 14 wherein each sensor of the plurality positioned in an area is configured to capture data regarding at least one of a temperature of the liquid coolant in the area, a temperature of the at least one battery block positioned in the area, an amount of current provided by the at least one battery block positioned in the area, an amount of current drawn by the at least one battery block positioned in the area, and a voltage provided by the at least one battery block positioned in the area.

17. The battery system of claim 14 wherein the circulation controller is configured to increase an amount of flow provided by the at least one circulator configured to circulate the liquid coolant in a particular area responsive to the at least one sensor positioned in the particular area detecting an increase in a temperature of the at least one battery block positioned in the particular area.

18. The battery system of claim 14 wherein the circulation controller is configured to decrease an amount of flow provided by the at least one circulator configured to circulate the liquid coolant in a particular area responsive to the at least one sensor positioned in the particular area detecting a decrease in a temperature of the at least one battery block positioned in the particular area.

19. The battery system of claim 14 wherein the circulation controller is configured to increase an amount of flow provided by the at least one circulator configured to circulate the liquid coolant in a particular area responsive to the at least one sensor positioned in the particular area detecting an increase in an amount of current drawn by the at least one battery block positioned in the particular area.

20. The battery system of claim 14 wherein the circulation controller is configured to increase an amount of flow provided by the at least one of circulator configured to circulate the liquid coolant in a particular area responsive to the at least one sensor positioned in the particular area detecting a decrease in a voltage provided by the at least one battery block positioned in the particular area.
